(19) United States
(12) Patent Application Publication
(10) Pub. No.: US 2026/0169226 A1
(43) Pub. Date: Jun. 18, 2026

(54) DATA TRANSMISSION DEVICE AND DATA TRANSMISSION METHOD

(71) Applicant: Industrial Technology Research Institute, Hsinchu (TW)

(72) Inventor: Ting-Hui CHEN, Hsinchu City (TW)

(73) Assignee: Industrial Technology Research Institute, Hsinchu (TW)

(21) Appl. No.: 18/980,164

(22) Filed: Dec. 13, 2024

(51) Int. Cl. G02B 6/293; G02B 6/35

(52) U.S. Cl. CPC G02B 6/29386; G02B 6/2935; G02B 6/3576

(57) ABSTRACT

A data transmission device includes a multiplexer, an optical transmitter, and a demultiplexer. The optical transmitter is coupled to the multiplexer. The demultiplexer is coupled to the optical transmitter. The multiplexer is configured to filter a plurality of specific wavebands of a first optical signal into a plurality of waveband optical signals. The optical transmitter transmits the waveband optical signals. The demultiplexer is configured to synthesize the waveband optical signals into a second optical signal.

### TECHNICAL FIELD

The present invention relates to a data transmission device and transmission method, and, in particular, it relates to a data transmission device and data transmission method.

### BACKGROUND

In recent years, the artificial intelligence industry has experienced a period of explosive growth, which is further boosting demand for optical communications.

With the growth in demand for efficient wavelength management of optical communications, existing wavelength selection switches (WSS) face the challenges of performance and integration. Traditional architectures have difficulty meeting the requirements for higher transmission rates and smaller sizes.

Therefore, an optical communication device with efficient wavelength management is a project that is extremely in need of research and development.

### SUMMARY

An embodiment of the present invention provides a data transmission device. The data transmission device incudes a multiplexer, a optical transmitter, and a demultiplexer. The optical transmitter is coupled to the multiplexer. The demultiplexer is coupled to the optical transmitter. The multiplexer is configured to filter a plurality of specific bands of a first optical signal into a plurality of waveband optical signals. The optical transmitter is configured to transmit the plurality of waveband optical signals. The demultiplexer is configured to selectively combine the plurality of waveband optical signals into a second optical signal.

An embodiment of the present invention provides a data transmission method. The data transmission method comprises the following steps: filtering a plurality of specific bands of a first optical signal into a plurality of waveband optical signals; transmitting a plurality of waveband optical signals; and combining a plurality of waveband optical signals into a second optical signal.

According to the technical content of the present disclosure, the data transmission device and the data transmission method shown in the present disclosure may achieve the effects of O band and C band that can operate in optical communication through the multiplexer, the optical transmitter, and the demultiplexer.

The data transmission device and the data transmission method shown in the present disclosure may further achieve efficient wavelength selection and management by combining the advantages of the RING resonator (or the microring resonator) and the Mach-Zehnder Interferometers. Furthermore, the present disclosure improves the transmission efficiency and stability of optical communication systems, reducing the size and cost of devices at the same time, and providing reliable solutions for next-generation optical networks.

### BRIEF DESCRIPTION OF THE DRAWINGS

FIG. 1 is a block diagram of a data transmission device according to one embodiment of the present disclosure.

FIG. 2 is a block diagram of other data transmission device according to one embodiment of the present disclosure.

FIG. 3 is a block diagram of another data transmission device according to one embodiment of the present disclosure.

FIG. 4 is an Application Scenario Diagram of a data transmission device according to one embodiment of the present disclosure.

FIG. 5 is an Application Scenario Diagram of another data transmission device according to one embodiment of the present disclosure.

FIG. 6 is an Application Scenario Diagram of another data transmission device according to one embodiment of the present disclosure.

FIG. 7 is a step flow diagram of a data transmission method according to one embodiment of the present disclosure.

### DETAILED DESCRIPTION

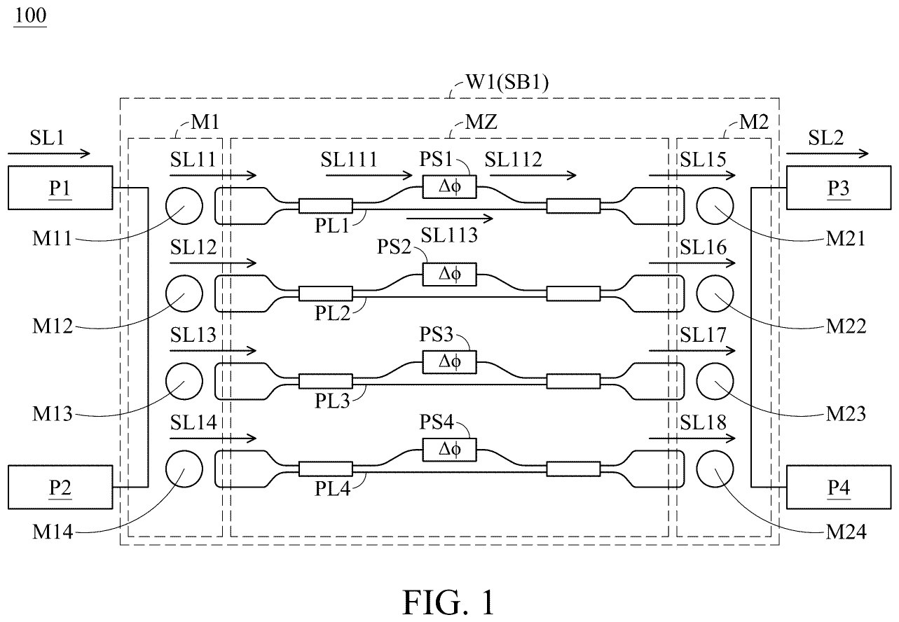

Please refer to FIG. 1. FIG. 1 is a block diagram of a data transmission device according to one embodiment of the present disclosure. As shown in FIG. 1, the data transmission device 100 may include a multiplexer M1, a optical transmitter MZ, and demultiplexer M2. The optical transmitter MZ may be coupled to the multiplexer M1. The demultiplexer M2 may be coupled to the optical transmitter MZ.

In some embodiments, the data transmission device 100 further include a plurality of ports P1˜P4, but the number of the plurality of ports is not limited thereto. In some embodiments, the multiplexer M1 may include a first port P1 and a second port P2. The demultiplexer M2 may include a third port P3 and a fourth port P4.

For example, each of the first port P1, the second port P2, the third port P3, and the fourth port P4 may be a node, the port, an interface, or a connector, but the present disclosure is not limited thereto.

In some embodiments, the multiplexer M1, the optical transmitter MZ, and the demultiplexer M2 of the data transmission device 100 may compose a wavelength selective switch (WSS) unit W1, but the present disclosure is not limited thereto.

In some embodiments, the multiplexer M1 is configure to filter a plurality of specific bands of a first optical signal SL1 into a plurality of waveband optical signals SL11˜SL14.

For example, multiplexer M1 may be composed of an optical waveguide, each of the plurality of waveband optical signals SL11˜SL14 may correspond to a specific band of the first optical signal SL1, and the wave bands of the plurality of waveband optical signals SL11˜SL14 may be different from each other, but the present disclosure is not limited thereto.

In some embodiments, the optical transmitter MZ may transmit the plurality of waveband optical signals SL11˜SL14.

For example, the optical transmitter MZ may receive the plurality of waveband optical signals SL11˜SL14 and output the plurality of waveband optical signals SL15˜SL18. The waveband optical signal SL11 may correspond to (or be the same as) the waveband optical signal SL15, the waveband optical signal SL12 may correspond to (or be the same as) the waveband optical signal SL16, the waveband optical signal SL13 may correspond to (or be the same as) the waveband optical signal SL17, and the waveband optical signal SL14 may correspond to (or be the same as) the waveband optical signal SL18, but the present disclosure is not limited thereto.

In some embodiments, the waveband optical signal SL11 may be different from the waveband optical signal SL15, the waveband optical signal SL12 may be different from the waveband optical signal SL16, the waveband optical signal SL13 may be different from the waveband optical signal SL17, and the waveband optical signal SL14 may be different from the waveband optical signal SL18, but the present disclosure is not limited thereto.

In some embodiments, the demultiplexer M2 is configured to selectively combine (or selectively control) the plurality of waveband optical signals SL15˜SL18 into a second optical signal SL2.

For example, the demultiplexer M2 may be composed of the optical waveguide, the demultiplexer M2 may combine the plurality of waveband optical signals SL15˜SL18 into the second optical signal SL2, but the present disclosure is not limited thereto. In some embodiments, the second optical signal SL2 may correspond to (or be the same as) the first optical signal SL1. In other embodiments, the second optical signal SL2 may be different from the first optical signal SL1, but the present disclosure is not limited thereto.

In some embodiments, the data transmission device 100 further includes a substrate SB1. In some embodiments, the material of the substrate SB1 may include one of Silicon (Si) and silicon nitride (SiN).

For example, the material of substrate SB1 may be silicon (Si) or silicon nitride (SiN), and the material of substrate SB1 may be a material that is related to silicon (Si) or silicon nitride (SiN), but the present disclosure is not limited thereto.

In some embodiments, the relevant material properties of silicon (Si) and silicon nitride (SiN) can be consistent with the following table 1, but the present disclosure is not limited thereto.

TABLE 1

| | silicon (Si) | | silicon nitride (SiN) | |
|---|---|---|---|---|
| optical loss | <12 | dB | <2 | dB |
| channel | 16 | μs | 15 | μs |
| switching time | | | | |

| | | |
|---|---|---|
| power consumption | smaller | greater |
| temperature | sensitive | insensitive |
| | (1 nm / 6.5° C.) | (1 nm / 40° C.) |

In some embodiments, a better solution for the material of the substrate SB1 in the present disclosure may be silicon nitride (SiN), but the present disclosure is not limited thereto.

In some embodiments, the multiplexer M1, the optical transmitter MZ, and the demultiplexer M2 are deposited on the front side of the substrate SB1.

For example, the multiplexer M1, the optical transmitter MZ, and the demultiplexer M2 may be deposited on the same side of the substrate SB1, but the present disclosure is not limited thereto.

In some embodiments, the multiplexer M1, the optical transmitter MZ, and the demultiplexer M2 may be arbitrarily deposited at the front or the back of the substrate SB1. For example, the multiplexer M1 may be deposited at the front of the substrate SB1, the optical transmitter MZ may be deposited at the back of the substrate SB1, and the demultiplexer M2 may be deposited at the front of the substrate SB1, but the present disclosure is not limited thereto.

In some embodiments, the multiplexer M1 may include a first microring resonator (MRR) M11˜M14, the optical transmitter MZ may include a plurality of thermo-optic switches PS1˜PS4, and the demultiplexer M2 may include a second microring resonator M21˜M24. The first microring resonator M11˜M14 may be deposited on one side of the optical transmitter MZ. The second microring resonator M21˜M24 may be deposed on the other side of the optical transmitter MZ. Each of the plurality of thermo-optic switches PS1˜PS4 may be configured to switch the wavelength, and the wavelength is related to the plurality of waveband optical signals SL11˜SL14. It should be noted that FIG. 1 illustrates the four specific bands of the first optical signal SL1 corresponding to the four first microring resonators M11˜M14 and the four second microring resonators M21˜M24, but the present disclosure is not limit a number of the first microring resonator and a number of the second microring resonator.

For example, the thermo-optic switches PS1˜PS4 may be a phase shifter, the thermo-optic switches PS1˜PS4 may adjust the optical phase of the optical signal through heating to obtain a optical signal which is different from the above optical signal, but the present disclosure is not limited thereto. Besides, the wavelength is related to the optical phase. In other words, the thermo-optic switches PS1˜PS4 may adjust the wavelength of the optical signal through heating to obtain a optical signal which is different from the above optical signal, but the present disclosure is not limited thereto.

More specifically, it takes the waveband optical signal SL11 as an example, the waveband optical signal SL11 may divide into a dividing optical signal SL111 and a dividing optical signal SL113. The dividing optical signal SL111 converts to the optical conversion signal SL112 through the thermo-optic switch PS1. At the same time, the phase of the optical conversion signal SL112 may be the same as or different from the dividing optical signal SL111 or SL113 to meet the specifications or requirements of transmission, but the present disclosure is not limited thereto.

Furthermore, the multiplexer M1 and the demultiplexer M2 may be the (at least one of) microring resonator or the ring resonator, but the present disclosure is not limited thereto. In some embodiments, each of the multiplexer M1 and the demultiplexer M2 may be any resonator which may be used for converting the optical signal, but the present disclosure is not limited thereto.

In some embodiments, the side or the other side of each of the specific wave band may have one of the microring resonator (For example, the first microring resonator M11 and the second microring resonator M21). For example, the first microring resonator M11 may transmit (or receive) the waveband optical signal SL11, the second microring resonator M21 may transmit (or output) the waveband optical signal SL15, but the present disclosure is not limited thereto. In some embodiments, a left side of the optical transmitter MZ may have a first group of microring resonators, a right side of the optical transmitter MZ may have a second group of microring resonators, the first group of microring resonators may include a plurality of microring resonators (For example, four microring resonators M11˜M14), and the second group of microring resonators may correspondingly include (or correspond to) the plurality of microring resonators (For example, four microring resonators M21˜M24), but the present disclosure is not limited thereto. In some embodiments, the first group of microring resonators may correspond to (or is the same as) the second group of microring resonators, but the present disclosure is not limited thereto.

In some embodiments, the operation of the plurality of thermo-optic switches PS1˜PS4 may be similar to each other, but the present disclosure is not limited thereto. In some embodiments, the operation of the plurality of thermo-optic switches PS1˜PS4 may be different from each other, and each of the thermo-optic switches PS1˜PS4 may be individually adjusted according to user requirements to modify their operating logic, but the present disclosure is not limited thereto.

In some embodiments, the waveband optical signal SL11 may convert to the waveband optical signal SL15 through the thermo-optic switch PS1, the waveband optical signal SL12 may convert to the waveband optical signal SL16 through the thermo-optic switch PS2, the waveband optical signal SL13 may convert to the waveband optical signal SL17 through the thermo-optic switch PS3, the waveband optical signal SL14 may convert to the waveband optical signal SL18 through the thermo-optic switch PS1, but the present disclosure is not limited thereto. In some embodiments, the plurality of waveband optical signals SL11˜SL14 may be different from the waveband optical signals SL15˜SL18, which may be converted by the thermo-optic switches PS1˜PS4, but the present disclosure is not limited thereto. In some embodiments, there have a specific phase difference (or a wavelength difference) between the plurality of waveband optical signals SL1˜SL14 and the waveband optical signals SL15˜SL18, which may be converted by the thermo-optic switches PS1˜PS4, but the present disclosure is not limited thereto.

In some embodiments, the optical transmitter MZ may include a Mach-Zehnder interferometer (MZI).

For example, the optical transmitter MZ may be a Mach-Zehnder interferometer optical switch (MZI-based Optical Switch), but the present disclosure is not limited thereto. In some embodiments, the optical transmitter MZ may be any interferometer which is related to the optical switch, but the present disclosure is not limited thereto.

In some embodiments, the optical transmitter MZ may be comprised by two 2×2 (and) 50:50 optical splitter and/or phase shifter, the optical splitter and/or the phase shifter is used to control an outputting direction of the optical signal, but the present disclosure is not limited thereto.

For example, the optical transmitter MZ may have four optical splitters, the optical splitters may divide same waveband optical signal as optical signal of same wave band, but the present disclosure is not limited thereto.

In some embodiments, there using the waveband optical signal SL11 for an example, the waveband optical signal SL11 may divide into the dividing optical signal SL111 and the dividing optical signal SL113 through the optical splitter, the dividing optical signal SL111 may convert to the optical conversion signal SL112 through the thermo-optic switch PS1, the path PL1 receives and transmits the dividing optical signal SL113, the optical conversion signal SL112 and the dividing optical signal SL113 combine to the waveband optical signal SL15 through the optical splitter, but the present disclosure is not limited thereto. In some embodiments, the operation of the paths PL2, PL3, and PL4 are similar to the operation of the path PL1, in order to concisely describe the contents of the present disclosure, there are not repeated herein.

In some embodiments, the optical transmitter MZ includes at least four wavelength channels, which are related to the plurality of waveband optical signals SL11˜SL14.

For example, one wavelength channel may include (be comprised by) two optical splitters, one phase shifter, and one path, the composition of (another) three wavelength channels are similar to the composition of the aforementioned wavelength channel, but the present disclosure is not limited thereto.

In some embodiments, the first band of the first optical signal SL1 may include an O band and a C band.

For example, a wave band of the first optical signal SL1 may be among the O band and the C band, that is, the wave band of the first optical signal SL1 may be among (or span) the O band and the C band at the same time, but the present disclosure is not limited thereto.

Besides, a wavelength range of the O band may be 1260 nm to 1360 nm, a wavelength range of the C band may be 1530 nm to 1565 nm.

In some embodiments, the wave band of the second optical signal SL2 may include the O band and the C band.

For example, the wave band of the second optical signal SL2 may be among the O band and the C band, that is, the wave band of the second optical signal SL2 may be among (or span) the O band and the C band at the same time, but the present disclosure is not limited thereto.

In some embodiments, the plurality of waveband optical signals SL11˜SL18 include the O band and the C band.

For example, each of the plurality of waveband optical signals SL1˜SL18 may be among (or span) the O band and the C band, that is, each of the plurality of waveband optical signals SL11˜SL18 may be among (or span) the O band and the C band at the same time, but the present disclosure is not limited thereto.

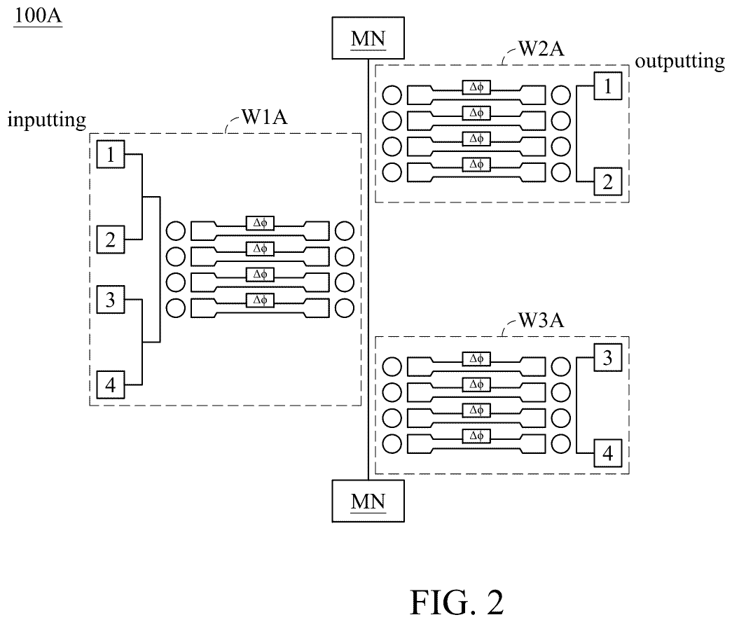

Please refer to FIG. 2. FIG. 2 is a block diagram of other data transmission device according to one embodiment of the present disclosure. As shown in FIG. 2, a data transmission system 100A may include the plurality of data transmission devices W1A˜W3A, a monitor MN, and a plurality of ports.

Please refer to FIG. 1 and FIG. 2. In some embodiments, the data transmission device 100 is modularized into a two-by-two modular device. In some embodiments, the first optical signal SL1 may correspond to (or be the same as) the second optical signal SL2.

For example, the data transmission device 100 of FIG. 1 may be further modularized into the two-by-two modular device W1A˜W3A of FIG. 2, the two-by-two modular device W1A˜W3A of FIG. 2 may have all or parts of functions in FIG. 1, but the present disclosure is not limited thereto.

In some embodiments, three sets of two-by-two modular devices W1A˜W3A may be expanded into a four-by-four modular device 100A. The four-by-four modular device 100A may include first two-by-two modular device W1A, the second two-by-two modular device W2A, and the third two-by-two modular device W3A. The port of the first two-by-two modular device W1A is coupled to the port of the second two-by-two modular device W2A, and the port of the first two-by-two modular device W2A is coupled to the port of the third two-by-two modular device W3A.

For example, the first two-by-two modular device W1A may be similar to the data transmission device 100 of FIG. 1, the second two-by-two modular device W2A may be similar to the data transmission device 100 of FIG. 1, the third two-by-two modular device W3A may be similar to the data transmission device 100 of FIG. 1, but the present disclosure is not limited thereto.

In some embodiments, the first two-by-two modular device W1A may correspond to the wavelength selective switch unit W1 of FIG. 1, the second two-by-two modular device W2A may correspond to the wavelength selective switch unit W1 of FIG. 1, the third two-by-two modular device W3A may correspond to the wavelength selective switch unit W1 of FIG. 1, but the present disclosure is not limited thereto.

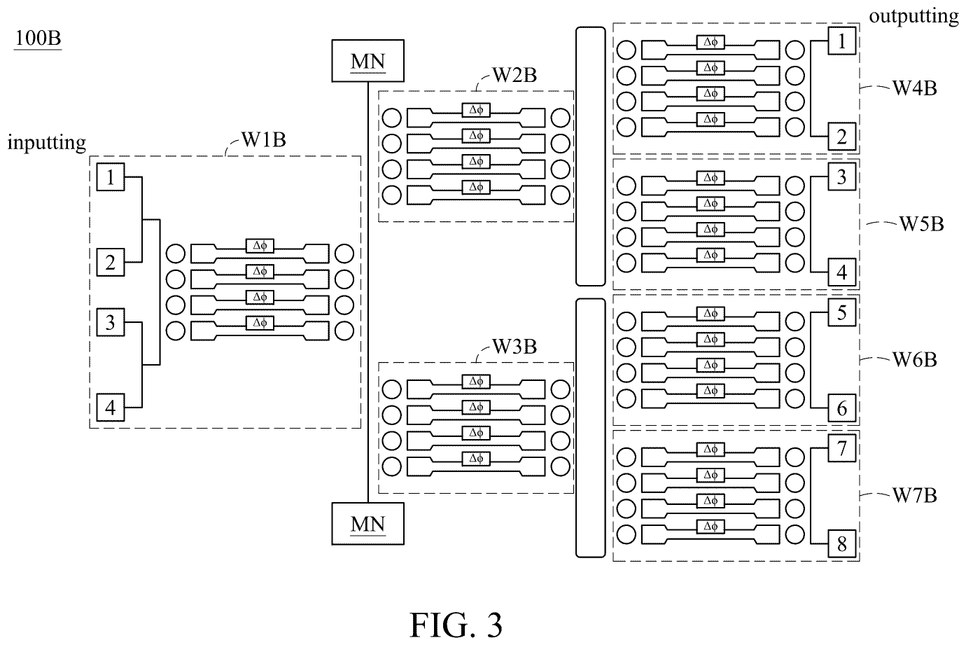

Please refer to FIG. 3. FIG. 3 is a block diagram of another data transmission device according to one embodiment of the present disclosure. As shown in FIG. 3, the data transmission system 100B may include a plurality of data transmission devices W1B˜W7B, the monitor MN, and a plurality of ports.

Please refer to FIG. 1, FIG. 2, and FIG. 3. In some embodiments, seven sets of two-by-two modular devices W1B˜W7B may be expanded into a four-by-eight modular device 100B, that is, the data transmission device 100 of FIG. 1 may be further modularized into the four-by-eight modular device 100B of FIG. 3. The two-by-two modular device W1B˜W7B of FIG. 3 may have all or parts of the functions in FIG. 1, but the present disclosure is not limited thereto.

For example, each of the seven sets of two-by-two modular device W1B˜W7B may be similar to the data transmission device 100 of FIG. 1, but the present disclosure is not limited thereto. In addition, the operation of the four-by-eight modular device 100B of FIG. 3 may be similar to the operation of the four-by-four modular device 100A of FIG. 2, in order to concisely describe the contents of the present disclosure, there are not repeated herein.

According to the data transmission device of the aforementioned one or multiple embodiments, the WSS unit of the present disclosure has good scalability. It may further achieve a wavelength selective switch with a greater architecture by being composed of a plurality of WSS units, but the present disclosure is not limited thereto.

According to the data transmission device (or the data transmission system) of the aforementioned one or multiple embodiments, the wavelength channel of the present disclosure may increase the number of the microring resonators and the thermo-optic switches in the architecture. For example, each of the WSS units change the number of the microring resonators and the thermo-optic switches, the number of the microring resonators and the thermo-optic switches may be eight sets. It allows for flexible adjustment of the number of ports and wavelength channels to meet different application requirements, but the present disclosure is not limited thereto.

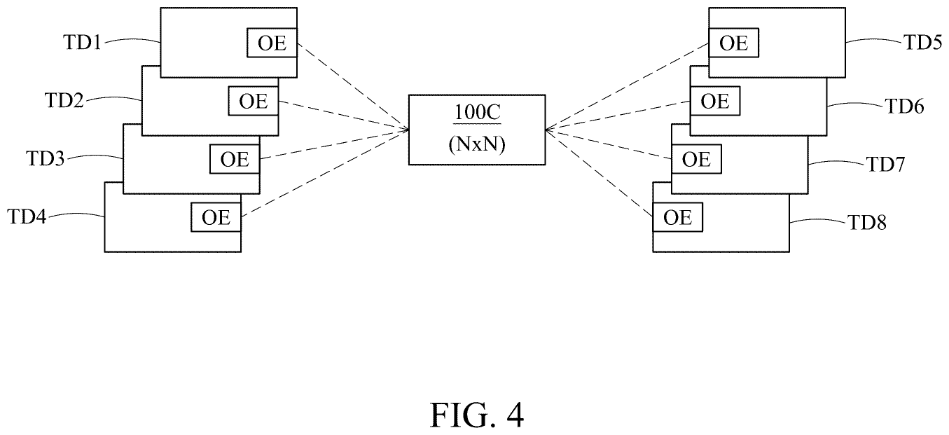

Please refer to FIG. 4. FIG. 4 is an Application Scenario Diagram of a data transmission device according to one embodiment of the present disclosure. As shown in FIG. 4, in some embodiments, there are a plurality of terminal devices TD1˜TD8 and a data transmission system 100C.

For example, the data transmission system 100C of FIG. 4 may correspond to the data transmission device 100 of FIG. 1, the data transmission system 100B of FIG. 2, or the data transmission system 100C of FIG. 3. When (N×N) in FIG. 4 may correspond to FIG. 1, (N×N) may be (2×2). When (N×N) in FIG. 4 may correspond to FIG. 2, (N×N) may be (4×4), but the present disclosure is not limited thereto.

In some embodiments, each of the plurality of terminal devices TD1˜TD8 may include a plurality of processor types, for example, a micro-processor unit (MPU), a central processing unit (CPU), a graphics processing unit (GPU), a microcontroller unit (MCU), a server, a field programmable gate array (FPGA), and other heterogeneous computing architectures, but the present disclosure is not limited thereto.

In some embodiments, each of the plurality of terminal devices TD1˜TD8 may cover (or include) optical transceiver modules, co-packaged optics (CPO), optical engines, and other high-efficiency optoelectronic components, but the present disclosure is not limited thereto.

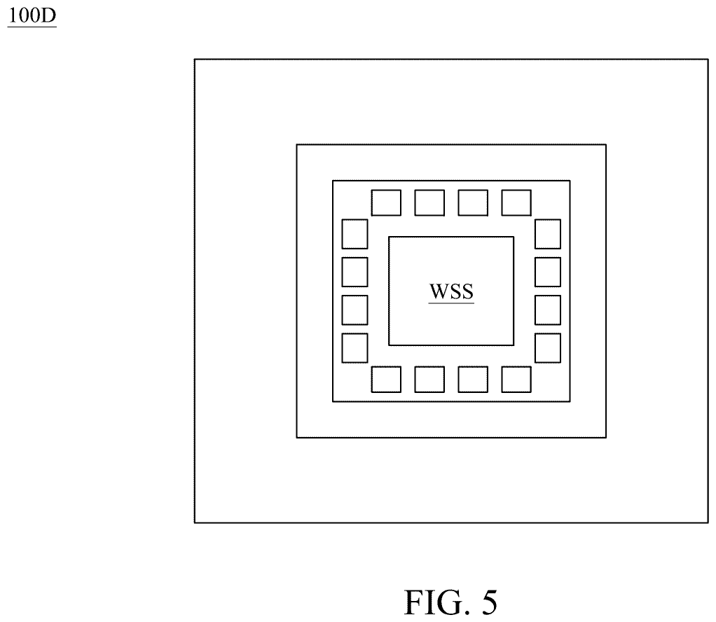

Please refer to FIG. 5. FIG. 5 is an Application Scenario Diagram of other data transmission device according to one embodiment of the present disclosure. As shown in FIG. 5, in some embodiments, FIG. 5 may be a Physical Block Diagram (or appearance block diagram) of the data transmission device 100D.

For example, the data transmission device 100D of FIG. 5 may correspond to the data transmission device 100 of FIG. 1, the data transmission system 100A of FIG. 2, the data transmission system 100B of FIG. 3, or the data transmission system 100C of FIG. 4, but the present disclosure is not limited thereto. In addition, compared with general technology, the co-packaged optics (CPO) components need at least two photoelectric conversions to transmit the optical signal. The data transmission device 100D of the present disclosure may directly switch the optical signal channel to transmit the optical signal, but the present disclosure is not limited thereto.

In some embodiments, the data transmission device 100D of FIG. 5 includes the wavelength selective switch WSS. For example, the data transmission device 100D may be the wavelength selective switch WSS, and the related operation and/or architecture of the wavelength selective switch WSS may be the same as (or similar to) the wavelength selective switch unit W1 of FIG. 1, but the present disclosure is not limited thereto.

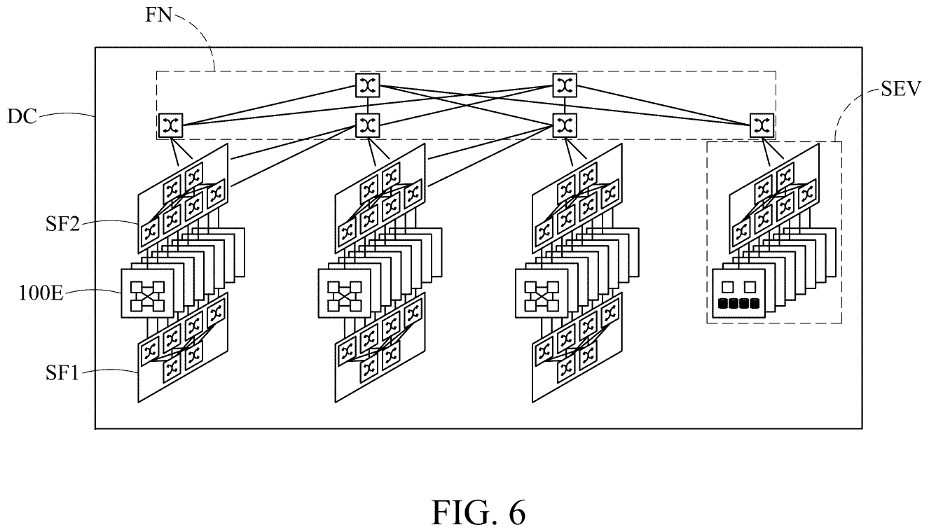

Please refer to FIG. 6. FIG. 6 is an Application Scenario Diagram of another data transmission device according to one embodiment of the present disclosure. As shown in FIG. 6, in some embodiments, a data center DC includes a first switching architecture SF1, the data transmission device 100E, a second switching architecture SF2, a front-end network FN and the server SEV. More specifically, in a connection relationship of the data center DC, the first switching architecture SF1 may be coupled to the data transmission device 100E, the data transmission device 100E may be coupled to the second switching architecture SF2, the second switching architecture SF2 may be coupled to the front-end network FN, and the front-end network FN may be coupled to the server SEV, but the present disclosure is not limited thereto.

For example, the data transmission device 100E of FIG. 6 may correspond to the data transmission device 100 of FIG. 1, the data transmission system 100A of FIG. 2, the data transmission system 100B of FIG. 3, the data transmission system 100C of FIG. 4, or the data transmission device 100D of FIG. 5, but the present disclosure is not limited thereto.

In comparing with general technology, the data center DC transmits data or signals through copper wires. However, when it runs an Artificial Intelligence Model, the transmission speed may not keep up with the speed of the calculation, resulting in waste of computing power. In addition, the longest transmission distance of copper wires may be as high as 1 meter, but the present disclosure is not limited thereto.

It is worth noting that the data transmission device 100, the data transmission system 100A, the data transmission system 100B, the data transmission system 100C, the data transmission device 100D, and the data transmission device 100E of the present disclosure may increase transmission speed and transmission distance to achieve the effect of accommodating more computing power, but the present disclosure is not limited thereto.

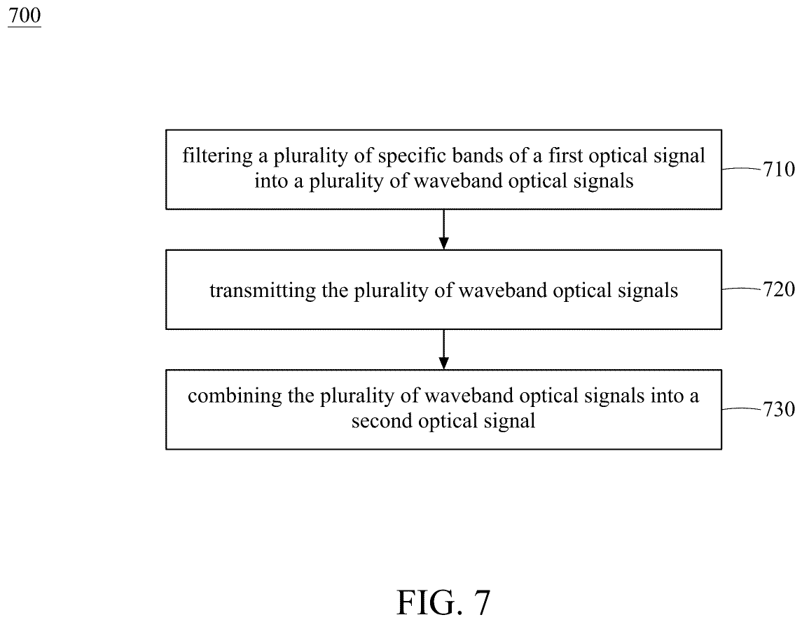

Please refer to FIG. 7. FIG. 7 is a step flow diagram of a data transmission method according to one embodiment of the present disclosure. The data transmission method 700 includes a plurality of steps 710˜730 and the following will be further explained in detail for steps 710˜730.

In the step 710, a plurality of specific bands of a first optical signal are filtered into a plurality of waveband optical signals.

Please refer to FIG. 1 and FIG. 7. In some embodiments, the multiplexer M1 is configure to filter the plurality of specific bands of the first optical signal SL1 into the plurality of waveband optical signals SL1˜SL14.

In the step 720, the plurality of waveband optical signals are transmitted.

Please refer to FIG. 1 and FIG. 7. In some embodiments, the optical transmitter MZ may transmit the plurality of waveband optical signals SL11˜SL14.

In the step 730, the plurality of waveband optical signals are selectively combined into a second optical signal.

Please refer to FIG. 1 and FIG. 7. In some embodiments, the demultiplexer M2 may be configured to selectively combine (or selectively control) the plurality of waveband optical signals SL15˜SL18 into the second optical signal SL2.

Please refer to FIG. 1 and FIG. 7. In some embodiments, the data transmission method 700 further includes the following steps. The multiplexer M1 is deposited on the front side of the substrate SB1. The optical transmitter MZ is deposited on the front side of the substrate SB1. The demultiplexer M2 is deposited on the front side of the substrate SB1. The data transmission device 100 is composed of the multiplexer M1, the optical transmitter MZ, and the demultiplexer M2.

In this embodiment, the material of the substrate SB1 may include one of silicon and silicon nitride. The multiplexer M1 is related to the plurality of specific bands, the optical transmitter MZ is related to the plurality of waveband optical signals SL11˜SL14, and the demultiplexer M2 is related to the second optical signal SL2.

In some embodiments, the multiplexer M1 may include the first microring resonator M11˜M14, the optical transmitter MZ may include the plurality of thermo-optic switches PS1˜PS4, and the demultiplexer M2 may include the second microring resonator M21˜M24. Each of the plurality of thermo-optic switches PS1˜PS4 is configured to switch the wavelength, and the wavelength is related to the plurality of waveband optical signals SL11˜SL14.

In some embodiments, the optical transmitter MZ may include the Mach-Zehnder interferometer. In some embodiments, the optical transmitter MZ may be a Mach-Zehnder interferometer optical switch.

In some embodiments, the multiplexer M1 may include the first port P1 and the second port P2. The demultiplexer M2 may include the third port P3 and the fourth port P4.

In some embodiments, the optical transmitter MZ may include the at least four wavelength channels. The at least four wavelength channels are related to the plurality of waveband optical signals SL11˜SL14.

In some embodiments, the first band of the first optical signal SL1 may include the O band, the C band, or both.

In some embodiments, the second band of the second optical signal SL2 may include the O band, the C band, or both. The plurality of waveband optical signals may include the O band, the C band, or both.

In some embodiments, the data transmission method 700 may further include the following steps: modularizing the data transmission device 100 into the two-by-two modular device W1A, W2A, or W3A. The first optical signal SL1 is the same as (or correspond to) the second optical signal SL2.

In some embodiments, the data transmission method 700 may further include the following steps. Three sets of two-by-two modular devices W1A˜W3A are expanded into a four-by-four modular device 100A. The four-by-four modular device 100A includes the first two-by-two modular device W1A, the second two-by-two modular device W2A, and the third two-by-two modular device W3A. The port of the first two-by-two modular device W1A is coupled to the port of the second two-by-two modular device W2A, the port of the first two-by-two modular device W1A is coupled to the port of the third two-by-two modular device W3A.

In some embodiments, the data transmission method 700 may be implemented by the data transmission device 100, the data transmission system 100A, the data transmission system 100B, the data transmission system 100C, the data transmission device 100D, and/or the data transmission device 100E, but the present disclosure is not limited thereto. In some embodiments, the data transmission method 700 may be implemented by the non-transitory computer-readable storage medium, but the present disclosure is not limited thereto. In some embodiments, data transmission method 700 may be implemented by the other system or server, but the present disclosure is not limited thereto.

In some embodiments, the data transmission method 700 may be an executable language of a processor, the processor may be the micro-processor unit (MPU), the central processing unit (CPU), the graphics processing unit (GPU), the microcontroller unit (MCU), and the server, but the present disclosure is not limited thereto.

In some embodiments, the data transmission method 700 may be stored in the memory. The memory may be the random-access memory (RAM), the read-only memory (ROM), the cache, the flash, the memory card, the hard drive (such as cloud/network hard drive/external hard drive), the optical disk, the portable disk, or the database, but the present disclosure is not limited thereto.

In some embodiments, the data transmission method 700 may be computer-readable instructions. The computer-readable instructions can be encoded in any type of programming language (code), algorithm, software, or firmware, but the present disclosure is not limited thereto.

According to the data transmission device (or the data transmission system) and the data transmission method of the aforementioned one or multiple embodiments may be used in general electronic, electromagnetic signal, and silicon photon transmission fields, but the present disclosure is not limited thereto. According to the data transmission device (or the data transmission system) and the data transmission method of the aforementioned one or multiple embodiments may add the switching components (For instance, photoelectric converters, etc.) or methods (For instance, photoelectric converting methods, etc.) between electronic signal, electromagnetic signal, and the optical signal, but the present disclosure is not limited thereto.

According to the data transmission device (or the data transmission system) and the data transmission method of the aforementioned one or multiple embodiments may achieve efficient wavelength selection and management by combining the advantages of the RING resonator (or the microring resonator) and the Mach-Zehnder Interferometers.

Furthermore, according to the data transmission device (or the data transmission system) and the data transmission method of the aforementioned one or multiple embodiments improve the transmission efficiency and stability of optical communication systems, reducing the size and cost of devices at the same time, and providing reliable solutions for next-generation optical networks. According to the data transmission device (or the data transmission system) and the data transmission method of the aforementioned one or multiple embodiments further have the following advantages: increasing interconnect capacity, decreasing conversion times, insensitive temperature, less optical loss, and lower cost, etc.

What is claimed is:

1. A data transmission device, comprising:
a multiplexer, configured to filter a plurality of specific bands of a first optical signal into a plurality of waveband optical signals;
a optical transmitter, coupled to the multiplexer, wherein the optical transmitter is configured to transmit the plurality of waveband optical signals; and
a demultiplexer, coupled to the optical transmitter, wherein the demultiplexer is configured to selectively combine the plurality of waveband optical signals into a second optical signal.

2. The data transmission device as claimed in claim 1, further comprising:
a substrate, wherein a material of the substrate comprises one of silicon and silicon nitride;
wherein the multiplexer, the optical transmitter, and the demultiplexer are deposited on a front side of the substrate.

3. The data transmission device as claimed in claim 1, wherein
the multiplexer comprises at least one first microring resonator, the optical transmitter comprises a plurality of thermo-optic switches, and the demultiplexer comprises at least one second microring resonator;
wherein the at least one first microring resonator is deposited on a side of the optical transmitter;
wherein the at least one second microring resonator is deposited on another side of the optical transmitter;
wherein each one of the plurality of thermo-optic switches is configured to switch a wavelength, and the wavelength is related to the plurality of waveband optical signals.

4. The data transmission device as claimed in claim 1, wherein
the optical transmitter comprises a Mach-Zehnder interferometer.

5. The data transmission device as claimed in claim 1, wherein
the multiplexer comprises a first port and a second port;
wherein the demultiplexer comprises a third port and a fourth port.

6. The data transmission device as claimed in claim 5, wherein
the optical transmitter comprises at least four wavelength channels, wherein the at least four wavelength channels are related to the plurality of waveband optical signals.

7. The data transmission device as claimed in claim 6, wherein
a first band of the first optical signal comprises an O band and a C band.

8. The data transmission device as claimed in claim 7, wherein
a second band of the second optical signal comprises the O band and the C band;
wherein the plurality of waveband optical signals comprise the O band and the C band.

9. The data transmission device as claimed in claim 1, wherein
the data transmission device is modularized into a two-by-two modular device;
wherein the first optical signal is same as the second optical signal.

10. The data transmission device as claimed in claim 9, wherein
three sets of the two-by-two modular devices are expanded into a four-by-four modular device;
wherein the four-by-four modular device comprises a first two-by-two modular device, a second two-by-two modular device, and a third two-by-two modular device;
wherein a port of the first two-by-two modular device is coupled to a port of the second two-by-two modular device, and the port of the first two-by-two modular device is coupled to a port of the third two-by-two modular device.

11. A data transmission method, comprising:
filtering a plurality of specific bands of a first optical signal into a plurality of waveband optical signals;
transmitting the plurality of waveband optical signals; and
combining the plurality of waveband optical signals into a second optical signal.

12. The data transmission method as claimed in claim 11, further comprising:
depositing a multiplexer on a front side of a substrate, wherein the multiplexer is related to the plurality of specific bands;
depositing a optical transmitter on the front side of the substrate, wherein the optical transmitter is related to the plurality of waveband optical signals; and
depositing a demultiplexer on the front side of the substrate, wherein the demultiplexer is related to the second optical signal; and
composing the multiplexer, the optical transmitter, and the demultiplexer into a data transmission device;
wherein a material of the substrate comprises one of silicon and silicon nitride.

13. The data transmission method as claimed in claim 12, wherein
the multiplexer comprises at least one first microring resonator, the optical transmitter comprises a plurality of thermo-optic switches, and the demultiplexer comprises at least one second microring resonator;
wherein each one of the plurality of thermo-optic switches is configured to switch a wavelength, and the wavelength is related to the plurality of waveband optical signals.

14. The data transmission method as claimed in claim 12, wherein
the optical transmitter comprises a Mach-Zehnder interferometer.

15. The data transmission method as claimed in claim 12, wherein
the multiplexer comprises a first port and a second port;
wherein the demultiplexer comprises a third port and a fourth port.

16. The data transmission method as claimed in claim 15, wherein
the optical transmitter comprises at least four wavelength channels, wherein the at least four wavelength channels are related to the plurality of waveband optical signals.

17. The data transmission method as claimed in claim 16, wherein
a first band of the first optical signal comprises an O band and a C band.

18. The data transmission method as claimed in claim 17, wherein
a second band of the second optical signal comprises the O band and the C band;
wherein the plurality of waveband optical signals comprise the O band and the C band.

19. The data transmission method as claimed in claim 12, further comprising:
modularizing the data transmission device into a two-by-two modular device;
wherein the first optical signal is same as the second optical signal.

20. The data transmission method as claimed in claim 19, further comprising:
expanding three sets of the two-by-two modular devices into a four-by-four modular device;
wherein the four-by-four modular device comprises a first two-by-two modular device, a second two-by-two modular device, and a third two-by-two modular device;
wherein a port of the first two-by-two modular device is coupled to a port of the second two-by-two modular device, and the port of the first two-by-two modular device is coupled to a port of the third two-by-two modular device.
